(19) United States
(12) Patent Application Publication
(10) Pub. No.: US 2005/0040556 A1
(43) Pub. Date: Feb. 24, 2005

(54) Cellulose acylate film and polarizing plate using the same

(75) Inventor: Satoshi Sakamaki, Kanagawa (JP)

Correspondence Address: YOUNG & THOMPSON, 745 SOUTH 23RD STREET, 2ND FLOOR, ARLINGTON, VA, 22202, US

(73) Assignee: FUJI PHOTO FILM CO., LTD., KANAGAWA (JP)

(21) Appl. No.: 10/937,406

(22) Filed: Sep. 10, 2004

Related U.S. Application Data
(62) Division of application No. 10/293,363, filed on Nov. 14, 2002, now abandoned.

(30) Foreign Application Priority Data
Nov. 16, 2001 (JP) 2001-351188

(51) Int. Cl. C09K 19/00; B29D 7/00

(52) U.S. Cl. 264/212; 264/216

(57) ABSTRACT

The cellulose acylate film has a lower degree of curling in water and is excellent in its processability, as a film suitable for manufacturing a polarizing plate. At least one portion of roll drying parts of a film manufacturing apparatus has a high-temperature drying zone where drying air having a temperature of 115° C. or more is blown on the film to dry thereof. The drying air is supplied by blowing it: (1) on a substrate side of the film; (2) on an air side of the film such that the drying air velocity becomes 3 m/s or less; and (3) on both sides of the film. The manufactured film has a curl radius of 25 mm or more when the film is dipped in water at 25° C. and a ratio between a plasticizer content of the substrate side and a plasticizer content of the air side from 1.2 to 2.0.

### CROSS REFERENCE TO RELATED APPLICATIONS

This application is a division of co-pending application Ser. No. 10/293,363, filed on Nov. 14, 2002, the entire contents of which are hereby incorporated by reference.

### BACKGROUND OF THE INVENTION

1. Field of the Invention

The present invention relates to a cellulose acylate film, and particularly to a cellulose acylate film to be used as a protective film for a polarizing plate and to a polarizing plate manufactured by using the cellulose acylate film.

2. Description of the Related Art

A cellulose acylate film (particularly, a cellulose acetate film) has moderate moisture permeability in addition to transparency and low birefringence. Thus, the cellulose acylate film is suitable for manufacturing process of a polarizing plate and is widely used as a protective film for the polarizing plate. In the manufacturing process of the polarizing plate, the cellulose acylate film is washed with water and then a polarizing film is laminated with the cellulose acylate film, and finally, thus laminated film is stamped out to produce a polarizing plate.

The cellulose acylate film is usually manufactured by a solvent casting method. That is, the cellulose acylate film is manufactured by flow-casting a concentrated solution (a dope) on a running endless substrate, drying the dope for imparting a self-supporting property thereto, and then stripping off the dope from the substrate continuously, and finally drying the stripped dope again. The film manufactured by the solvent casting method has good planarity as well as less optical anisotropy, so that this film is suitable for the protective film on the polarizing film. However, a concentration distribution of the solvent arises in a thickness direction of the dope when the dope is dried on the substrate, causing a problem that a hydrophobic plasticizer moves in accordance with the solvent distribution. The hydrophobic plasticizer is optimally blended with hydrophilic cellulose acylate such that dimensional stability of the film is controlled relative to humidity. Therefore, if the plasticizer moves and consequently the hydrophobic property varies in the thickness direction of the film, a degree of curling when the film absorbs water becomes higher, so that various problems arise such as creases and wrinkles which are produced during a process of laminating the polarizing film, unevenness of coating at a time of coating with a functional layer, and dust which is created due to contact with other materials during transferring. In addition, there is a disadvantage that a finished polarizing plate easily warps.

Japanese Patent Publication No. 54-26582 describes a method for controlling a degree of curling, in which moist heat air having a dew point of 40° C. or more is blown on a surface intended to be curled. Japanese Patent Application Publication No. 04-281448 describes a method for blowing solvent gas or steam having a temperature of 100 to 150° C. on a surface which is intended to be curled. These methods are very effective as procedures for controlling the degree of curling in a specific atmosphere. However, it has been required to increase a drying temperature of the film more than ever, so that these methods have become insufficient for preventing the film from being curled in a humid atmosphere, especially in water.

Japanese Patent Application Publication No. 2001-200098 describes a method for introducing a propionyl group or a butyryl group as a 6-position substituent of cellulose. Although this method can make the degree of curling in water lower than ever, there are some problems as follows. That is, the cost of raw materials becomes higher than that of common cellulose acetate, and preferable protective films for the polarizing plates cannot be manufactured due to a change in film characteristics such as birefringence and mechanical strength.

For preventing the film from curling in water, a method described below is known to be effective. That is, a film is stripped off from a substrate when the film contains a volatile component at a very high level such as 150% or more on the basis of a film dry weight, and then the film is dried from both sides thereof. The stripping off at such a high volatile content can be achieved by cooling the substrate to a temperature of 10° C. or less as described in Japanese Patent Publication No.05-17844. However, if the film thus manufactured is used as the protective film for the polarizing plate, there are some problems that chipping and stripping are caused at edge portions of the film at a time of stamping thereof and consequently a yield ratio of the film tends to be reduced.

Against the backdrop described above, a cellulose acylate film which has a lower degree of curling in water and is excellent in processability for stamping, for example, is desired as a film suitable for manufacturing a polarizing plate. However, the fact is that the film which has properties suitable for manufacturing the polarizing plate has not yet been standardized sufficiently.

### SUMMARY OF THE INVENTION

The present invention is achieved in view of such circumstances, and an object of the present invention is to provide a cellulose acylate film that has a lower degree of curling in water and excellent processability, as a film suitable for manufacturing a polarizing plate. Another object of the present invention is to provide a polarizing plate manufactured by using the cellulose acylate film.

In order to achieve the above-described object, the present invention is directed to a cellulose acylate film, wherein: a ratio of a plasticizer content of a half portion of the film along a thickness direction thereof to a plasticizer content of the other half portion of the film is between 1.2 and 2.0; and a curl radius of the film in water at a temperature of 25° C. is 25 mm or more.

With respect to characteristics of the cellulose acylate film suitable for manufacturing the polarizing plate, the present inventor has attained knowledge that the cellulose acylate film is excellent in its processability, has a lower degree of curling in water, and is suitable for manufacturing the polarizing plate when a ratio of a plasticizer content of one-half portion of the cellulose acylate film along the thickness direction thereof to a plasticizer content of the other-half portion of the cellulose acylate film along the thickness direction thereof is from 1.2 to 2.0 and when a curl curvature radius in water at a temperature of 25° C. is 25 mm or more. Therefore, according to the cellulose acylate film of the present invention which has a lower degree of curling when washing with water, the polarizing film can be easily laminated with the cellulose acylate film and also subjected to the stamping processing without producing chipping or stripping on the edge portions of the laminated film.

If the above-described plasticizer content ratio is too low, the stamping processability of the cellulose acylate film deteriorates, and if the plasticizer content ratio is too high, the degree of curling in water becomes larger. The plasticizer content ratio, which provides preferable results with respect to both of the processability and the degree of curling in water, may range from 1.2 to 2.0, and preferably from 1.3 to 1.8, and more preferably from 1.4 to 1.7.

### BRIEF DESCRIPTION OF THE DRAWINGS

The nature of this invention, as well as other objects and advantages thereof, will be explained in the following with reference to the accompanying drawings, in which like reference characters designate the same or similar parts throughout the figures and wherein:

FIG. 1 is a schematic diagram showing an overall configuration of an apparatus which manufactures a cellulose acylate film according to the present invention;

FIG. 2 is a schematic diagram showing an overall configuration of a manufacturing apparatus comprising a high-temperature drying zone which is different from that shown in FIG. 1; and

FIG. 3 is a schematic diagram showing an overall configuration of an apparatus which manufactures the film in a flow-cast manner which is different from that shown in FIG. 1.

### DETAILED DESCRIPTION OF THE PREFERRED EMBODIMENTS

Preferred embodiments of a cellulose acylate film according to the present invention and a polarizing plate using the cellulose acylate film will be described below in more detail with reference to accompanying drawings.

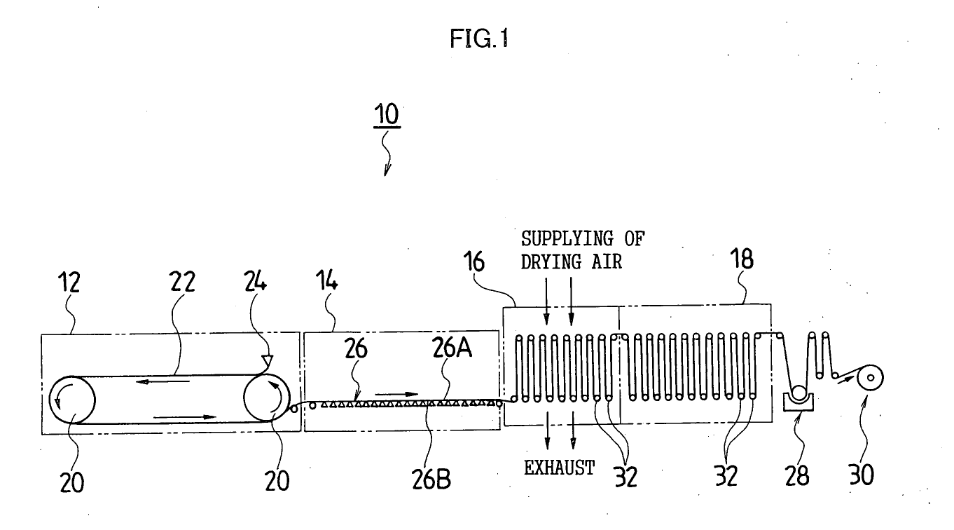

FIG. 1 is a schematic diagram showing an overall configuration of a manufacturing apparatus 10 which manufactures a cellulose acylate film according to the present invention.

As shown in FIG. 1, the manufacturing apparatus 10 is comprised of a flow-casting part 12, a tenter drying part 14, and roll drying parts 16 and 18.

The flow-casting part 12 is provided with a pair of drums 20 and 20 around which an endless band (corresponding to a substrate) 22 is wound. The band 22 is made of stainless steel for example, whose surface is provided with a mirror finish. This band 22 is run by rotationally driving one of the pair of drums 20 and 20 and goes around the pair of drums 20 and 20.

On a surface of the band 22 going around the drums, a dope extruded from a die 24 in the form of film is flow-cast. This dope is a mixture in which an appropriate amount of hydrophobic plasticizer is mixed with cellulose acylate. The dope which has flow-cast on the band 22 is dried by hot air for example, and then stripped off from the band 22 after some degree of self-supporting property is imparted to the dope. Both ends of the stripped film 26 are fixed by clips or pins (not shown) to ensure its planarity and then conveyed to the tenter drying part 14. In this tenter drying part 14, the film 26 is conveyed with tension applied in its width direction and dried to a certain extent. After passing through the tenter drying part 14, the film 26 is further dried in the roll drying parts 16 and 18.

At the roll drying parts 16 and 18, the film 26 is conveyed by a plurality of rolls 32 and 32, . . . over which the film 26 is looped while hot air (dry air) is blown on the film 26. Thus dried film 26 is conveyed to a curl correction apparatus 28 if necessary, from which a solvent gas or steam is blown on an air side 26B of the film 26 to control a degree of curling of the film 26. The film 26 whose degree of curling has been controlled is wound into a roll to form a roll film 30.

When steam is blown on the film 26 by the curl correction apparatus 28, a temperature of the film 26 is preferably lowered as long as the steam does not condense on a surface of the film 26. In such instances, the temperature of the film 26 may be controlled by adjusting a temperature of air supplied in the room or temperatures of cooling contact rolls or back-up rolls at the time of processing, for example.

At least one portion of the above-described roll drying parts 16 and 18 has a high-temperature drying zone where drying air having a temperature of 115° C. or more is blown on the film. In the high-temperature drying zone, the drying air having a temperature of 115° C. or more is supplied by any of the methods as follows: (1) the drying air is blown on a substrate side 26A of the film 26; (2) the drying air is blown on an air side 26B of the film 26 such that the air has a velocity of 3 m/s or less at the air side 26B; and (3) the drying air is blown on both of the substrate side 26A and the air side 26B of the film 26. Although a direction of blowing the drying air is not particularly limited, it is preferable that the drying air flows downwardly from an air supplying port (not shown) provided at a ceiling side to an exhausting port (not shown) provided at a floor side such that dust from the processes is prevented from rising and from being applied to the film. Therefore, the manufacturing apparatus 10 shown in FIG. 1 is suitable for supplying air in accordance with the method (1) in which drying air having a temperature of 115° C. or more flows downwardly from a substrate side 26A by providing an air supplying port at a ceiling of the roll drying part 16 and an exhausting port at a floor of the roll drying part 16, for example.

Within the high-temperature drying zone, a plurality of exhausting ports may also be provided such that two exhausting ports are positioned upstream and downstream of a conveying direction of the film 26 respectively or two exhausting ports which are provided at the ceiling and the floor respectively are positioned upstream and downstream of the air supplying position.

The roll drying parts 16 and 18 may also be provided with a low-temperature drying zone in which drying air having a temperature of less than 115° C. is blown on the film, in addition to the high-temperature drying zone. Methods for supplying air in the low-temperature drying zone are not limited to the above-described methods (1) to (3), and the air may also be supplied in accordance with a method other than the above-described methods (1) to (3). If all of the roll drying parts 16 and 18 are used as a low-temperature drying zone, heat dimensional stability of the film 26 becomes lower. In such a case, it is preferable that a high-temperature drying zone is provided at any one of the processes until the film is rolled up.

The film 26 thus dried and manufactured is used as a protective film for a polarizing plate when manufacturing the polarizing plate, for example. In the process for manufacturing the polarizing plate, the film 26 is washed with water, and the polarizing film is laminated with the film 26 and then stamped into the polarizing plate.

Next, operation of the manufacturing apparatus 10 configured as described above will be described.

The manufacturing apparatus 10, which comprises a high-temperature drying zone where drying air having a temperature of 115° C. or more flows therein, can rapidly dry the film 26 and also obtain the film 26 with a good heat dimensional stability. However, the drying air having a temperature of 115° C. or more has large drying capacity, so that there is a possibility that a degree of curling in water becomes higher depending on a blowing direction or a blowing velocity of the drying air. According to the embodiment of the present invention in which a blowing direction and a blowing velocity of the drying air having a temperature of 115° C. or more are restricted by the methods (1) to (3), the heat dimensional stability of the film 26 can be improved while preventing the degree of curling in water from becoming higher.

That is, according to the method (1), drying air is blown on the substrate side 26A containing a large amount of plasticizer in order to dry the film 26. Therefore, the degree of curling does not become higher even when the drying air having a temperature of 115° C. or more is blown on the film 26.

According to the method (2) in which drying air having a temperature of 115° C. or more is blown on the air side 26B containing a less amount of plasticizer, the film is prevented from being suddenly dried by setting a velocity of the drying air at the air side 26B at 3 m/s or less. Consequently, a degree of curling in water does not become higher and defective polarizing plates will not be manufactured.

According to the method (3) in which drying air having a temperature of 115° C. or more is blown on the air side 26B containing a less amount of plasticizer as well as on the substrate side 26A, both sides of the film 26 are approximately evenly dried. Consequently, a degree of curling in water will not become higher.

In this manner, the film 26 can be dried without making the degree of curling in water higher by blowing the drying air having a temperature of 115° C. or more on the film 26 in accordance with the methods (1) to (3). Thus obtained film 26 has a curling characteristic and a plasticizer distribution as described below. That is, a curvature radius of curling when the film is dipped in water at 25° C. is 25 mm or more, and a ratio between a plasticizer content of the substrate side 26A and a plasticizer content of the air side 26B, when the film 26 is divided into two portions along the thickness direction thereof, determined from a gas chromatography for example is 1.2 to 2.0.

The film 26, having the above-described characteristic that the curvature radius in water at 25° C. is 25 mm or more, is suitable for a process for laminating a polarizing film with the film 26 because a degree of curling at the time of washing with water for example is very low. That is, the polarizing film can be easily laminated with the film 26 having been washed with water and a polarizing plate thus fabricated can be prevented from warping because a degree of curling of the film 26 at the time of washing with water is very low.

In addition, the film 26 having the above-described characteristic that the plasticizer content ratio is 1.2 to 2.0 is suitable for both processes for laminating the polarizing film with the film 26 and for stamping out the laminated film. That is, if the plasticizer content ratio is less than 1.2, chipping and stripping are caused at edge portions of the laminated film at the time of stamping out thereof. However, if the plasticizer content ratio is 1.2 or more, processability at the time of stamping out the laminated film is improved and the laminated film can be subjected to the stamping processing without producing chipping or stripping. On the other hand, if the plasticizer content ratio is more than 2.0, the degree of curling becomes higher and creases and wrinkles are produced during the lamination. However, if the plasticizer content ratio is 2.0 or less, the degree of curling becomes lower and consequently the polarizing film can be laminated with the film 26 reliably without producing creases and wrinkles.

Preferably, the plasticizer content ratio ranges from 1.3 to 1.8, and more preferably from 1.4 to 1.7.

The plasticizer content ratio depends not only on the methods for supplying drying air but also on volatile contents when stripping off the film 26 from the band 22, and for example, the volatile content at the time of stripping which is 150% or more on the basis of a film dry weight is not preferable because the plasticizer content ratio tends to become less than 1.2. Therefore, it is necessary to make the volatile content at the time of stripping lower than 150%. The volatile content at the time of stripping is preferably 120% or less, and is more preferably 100% or less, and is even more preferably 80% or less. However, if the volatile content at the time of stripping becomes 25% or less, productivity is significantly decreased and a difference between a plasticizer content of the substrate side and a plasticizer content of the air side becomes too large. Therefore, the volatile content is preferably 25% or more.

In this manner, the film 26 manufactured according to this embodiment has a lower degree of curling in water and is excellent in stamping processability, because a ratio of a plasticizer content of one-half portion of the film 26 along the thickness direction thereof to a plasticizer content of the other-half portion of the film 26 is from 1.2 to 2.0 and a curl radius when dipping the film 26 in water at 25° C. is 25 mm or more. Therefore, a yield in the manufacturing process of the polarizing plate can be improved.

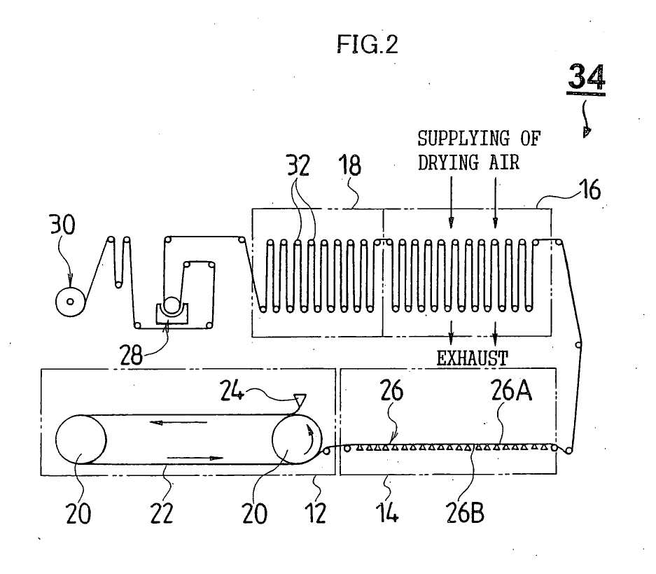

The above-described manufacturing apparatus 10 is an example suitable for supplying drying air having a temperature of 115° C. or more in accordance with the method (1), but it is preferable that a manufacturing apparatus 34 shown in FIG. 2 is used if the drying air is supplied in accordance with the method (2). In the manufacturing apparatus 34 shown in FIG. 2, the film 26 after passing through the tenter drying part 14 is introduced into the roll drying parts 16 and 18 with the film 26 being reversed upside down. The roll drying parts 16 and 18 are provided with a high-temperature drying zone, and a ceiling side of the high-temperature zone is provided with a port for supplying drying air (not shown) having a temperature of 115° C. or more and a floor side of the high-temperature zone is provided with an exhausting port (not shown). Therefore, the drying air having a temperature of 115° C. or more flows downwardly and is blown on an air side 26B of the film 26. In this case, it is possible to prevent a degree of curling in water from becoming higher by regulating an air velocity at the air side 26B to 3 m/s or less.

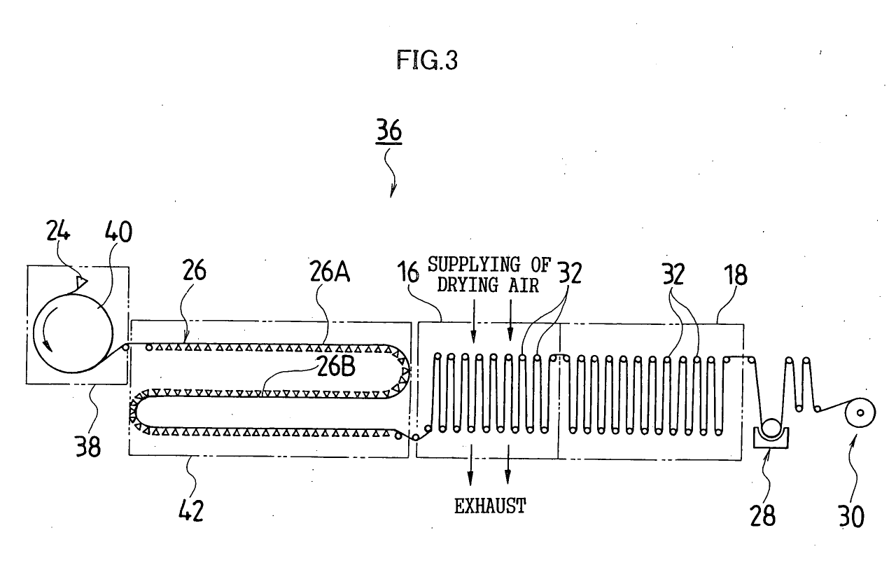

Although FIGS. 1 and 2 show manufacturing apparatus 10 and 34 respectively which are provided with band types of flow-casting parts 12, the present invention may also be applied to a manufacturing apparatus 36 comprising a drum type of flow-casting part 38 as show in FIG. 3. That is, the flow-casting part 38 is provided with a rotating drum 40, and a dope extruded from the die 24 is flow-cast on a surface of the drum 40. The flow-cast dope is stripped off after the self-supporting property is imparted thereto by cooling and is introduced into a tenter drying part 42 as the film 26. The introduced film 26 is dried to a certain extent and further introduced into the roll drying parts 16 and 18. In this case, it is also possible to manufacture the film 26 which has a lower degree of curling in water and is excellent in the stamping processability, by providing the roll drying parts 16 and 18 with the high-temperature zone.

In the present invention, the film 26 manufactured may have the above-described characteristics, and the manufacturing method and apparatus are not limited to the above-described embodiments.

### EXAMPLE

As Examples 1 and 2 and Comparative Examples 1 and 2, films having different characteristics were manufactured and subjected to saponification, and then used for fabricating polarizing plates. The followings are conditions of manufacturing respective films, conditions of preparing dopes, conditions of saponification, and conditions of fabricating the polarizing plates.

Film Manufacturing Conditions of Example 1

Using the manufacturing apparatus 10 shown in FIG. 1, a dope A was flow-cast to manufacture the film 26. That is, the dope A was extruded from the die 24 and was flow-cast on the band 22, and after the dope A was dried until the self-supporting property was imparted thereto, the film 26 was stripped off from the band 22 and introduced into the tenter drying part 14. A volatile content at the time of stripping was 66%.

In the tenter drying part 14, drying air having a temperature of 130° C. was supplied to each side of the film 26, and the maximum speed of the drying air blowing on the film 26 was set to become 3.0 m/s. In the roll drying part 16, drying air having a temperature of 120° C. was supplied to the substrate side 26A of the film 26 and exhausted from the air side 26B of the film 26, and in the roll drying part 18, drying air having a temperature of 140° C. was supplied to the substrate side 26A of the film 26 and exhausted from the air side 26B of the film 26. At this moment, the maximum speed of the drying air blowing on the film 26 in each of the roll drying parts 16 and 18 was 5.0 m/s. Next, using the curl correction apparatus 28, steam having a temperature of 145° C. was blown on the air side 26B of the film 26 dried in the roll drying parts 16 and 18 at a flow rate of 3 g/m², and then the film 26 was rolled up. The film 26 thus manufactured had a thickness of 79 μm and its curl curvature radius in water at 25° C. was 33 mm. The plasticizer content ratio when the film 26 was divided into two portions along the thickness direction thereof (the substrate side 26A/the air side 26B) was 1.63.

Film Manufacturing Conditions of Example 2

Using the manufacturing apparatus 34 shown in FIG. 2, the dope A was flow-cast to manufacture the film 26. That is, the dope A was extruded from the die 24 and was flow-cast on the band 22, and after the dope A was dried until the self-supporting property was imparted thereto, the film 26 was stripped off from the band 22 and introduced into the tenter drying part 14. A volatile content at the time of stripping was 70%.

In the tenter drying part 14, drying air having a temperature of 110° C. was supplied to each side of the film 26, and the maximum speed of the drying air blowing on the film 26 was set to become 10.0 m/s. In the roll drying part 16, drying air having a temperature of 120° C. was supplied to the air side 26B of the film 26 and exhausted from the substrate side 26A of the film 26, and in a roll drying part 18, drying air having a temperature of 130° C. was supplied to the air side 26B of the film 26 and exhausted from the substrate side 26A. At this moment, the maximum speed of the drying air blowing on the film 26 in each of the roll drying parts 16 and 18 was 1.5 m/s. Next, using the curl correction apparatus 28, steam having a temperature of 145° C. was blown on the air side 26B of the film 26 dried in the roll drying parts 16 and 18 at a flow rate of 8 g/m², and then the film 26 was rolled up. The film 26 thus manufactured had a thickness of 79 μm and its curl curvature radius in water at 25° C. was 35 mm. The plasticizer content ratio when the film 26 was divided into two portions along the thickness direction thereof (the substrate side 26A/the air side 26B) was 1.61.

Film Manufacturing Conditions of Comparative Example 1

Using the manufacturing apparatus 34 shown in FIG. 2, the dope A was flow-cast to manufacture the film 26. That is, the dope A was extruded from the die 24 and was flow-cast on the band 22, and after the dope A was dried until the self-supporting property was imparted thereto, the film 26 was stripped off from the band 22 and introduced into the tenter drying part 14. A volatile content at the time of stripping was 70%.

In the tenter drying part 14, drying air having a temperature of 110° C. was supplied to each side of the film 26, and the maximum speed of the drying air blowing on the film 26 was set to become 10.0 m/s. In the roll drying part 16, drying air having a temperature of 120° C. was supplied to the air side 26B of the film 26 and exhausted from the substrate side 26A of the film 26, and in the roll drying part 18, drying air having a temperature of 130° C. was supplied to the air side 26B of the film 26 and exhausted from the substrate side 26A. At-this moment, the maximum speed of the drying air blowing on the film 26 in each of the roll drying parts 16 and 18 was 7.0 m/s. Next, using the curl correction apparatus 28, steam having a temperature of 145° C. was blown on the air side 26B of the film 26 dried in the roll drying parts 16 and 18 at a flow rate of 8 g/m², and then the film 26 was rolled up. The film 26 thus manufactured had a thickness of 79 μm and its curl curvature radius in water at 25° C. was 25 mm. The plasticizer content ratio when the film 26 was divided into two portions along the thickness direction thereof (the substrate side 26A/the air side 26B) was 1.67.

Film Manufacturing Conditions of Comparative Example 2

Using the manufacturing apparatus 36 shown in FIG. 3, a dope B was flow-cast to manufacture the film 26. That is, the dope B was extruded from the die 24 and was flow-cast on the drum 40 whose surface temperature was −3° C., and after the self-supporting property was imparted to the dope B, the dope B was stripped off as the film 26 and introduced into the tenter drying part 42. A volatile content at the time of stripping was 270%.

In the tenter drying part 42, drying air having a temperature of 80 to 130° C. was supplied to each side of the film 26, and the maximum speed of the drying air blowing on the film 26 was set to become 10.0 m/s. In the roll drying part 16, drying air having a temperature of 120° C. was supplied to the substrate side 26A of the film 26 and exhausted from the air side 26B of the film 26, and in the roll drying part 18, drying air having a temperature of 140° C. was supplied to the substrate side 26A of the film 26 and exhausted from the air side 26B. At this moment, the maximum speed of the drying air blowing on the film 26 in each of the roll drying parts 16 and 18 was 7.0 m/s. Next, using the curl correction apparatus 28, steam having a temperature of 145° C. was blown on the air side 26B of the film 26 dried in the roll drying parts 16 and 18 at a flow rate of 3 g/m², and then the film 26 was rolled up. The film 26 thus manufactured had a thickness of 79 μm and its curl curvature radius in water at 25° C. was 100 mm. The plasticizer content ratio when the film 26 was divided into two portions along the thickness direction thereof (the substrate side 26A/the air side 26B) was 1.08.

Preparation of Dope A

To 100 parts by weight of solids comprised of 89.3% by weight of cellulose triacetate (a degree of substitution 2.8), 7.1% by weight of triphenyl phosphate, and 3.6% by weight of biphenyldiphenylphosphate, an appropriate amount of a silica particle dispersion was added and further a mixed solvent comprised of 87% by weight of dichlormethane and 13% by weight of methanol was added. This mixture was stirred to be dissolved and consequently a dope could be prepared. Thus prepared dope A had a solid concentration of 19.0%.

Preparation of Dope B

To 100 parts by weight of solids comprised of 89.5% by weight of cellulose triacetate (a degree of substitution 2.8), 7.0% by weight of triphenyl phosphate, and 3.5% by weight of biphenyldiphenylphosphate, an appropriate amount of a mixed solvent comprised of 82% by weight of methylene chloride, 15% by weight of methanol, and 3% by weight of n-butanol was added. This mixture was stirred to be dissolved and consequently a dope could be prepared. Thus prepared dope B had a solid concentration of 23.0%.

Saponification The film 26 manufactured as described above was treated with a 1.5N aqueous solution of NaOH at 50° C. for 180 seconds, and the treated film 26 was neutralized and washed with water and dried. The surface of the film 26 was thus subjected to saponification.

Fabrication of Polarizing Plate

A PVA film manufactured by KURARAY CO., LTD. having a thickness of 75 μm was dipped in an aqueous solution of 0.3 g/l of iodine and 18.0 g/l of potassium iodide at 25° C., then the PVA film was stretched by 5.0 times longer within an aqueous solution of 80 g/l of boric acid, 30 g/l of potassium iodide, and 10 g/l of zinc chloride at 50° C., and the PVA film was then dried for five minutes at 60° C. Then, each side of the stretched PVA film was laminated with the film 26, which had been subjected to saponification and washed with water to remove any dust on the surface thereof, with an adhesive of a 4% aqueous solution of PVA (PVA-117H manufactured by KURARAY CO., LTD.) by continuously pressurizing the laminated film with nipping rollers. Thereafter, the obtained lamination was dried at 80° C., and a polarizing plate was thus obtained. A time period for dipping the film into a stain solution was appropriately controlled such that a transmittance of the polarizing plate became (42±0.5)%, and a polarization degree of the obtained polarizing plate was 99.7 to 99.9%.

Stamping of Polarizing Plate

A circular stamping die having a diameter of 30 mm was applied to the polarizing plate and then hammered to stamp out the polarizing plate in which the polarizing film was laminated with the films 26.

Results of manufacturing the polarizing plates under the above-described conditions are summarized in Table 1.

TABLE 1

| | Direction and maximum | | | | | |
|---|---|---|---|---|---|---|
| | speed of supplying air | Plasticizer | Curvature | Lamina- | Stamping | Overall |
| | having a temperature | content | radius in | tion | process- | evalua- |
| | of 115° C. or more | ratio | water | process | ability | tion |
| Example 1 | Both sides or | 1.63 | 33 | Good | Good | Good |
| | substrate side | | | | | |
| Example 2 | Air side, 3 m/s or less | 1.61 | 35 | Good | Good | Good |
| Comparative | Air side, over 3 m/s | 1.67 | 22 | Poor | Good | Poor |
| Example 1 | | | | | | |
| Comparative | Both sides or | 1.08 | 100 | Good | Poor | Poor |
| Example 2 | substrate side | | | | | |

As can be seen from Table 1, in Comparative Example 1, the curvature radius in water of the film 26 was very small and its value was 22 mm, and the film 26 was largely curled toward the substrate side 26A when washing with water. Consequently, a handling property during the lamination process was degraded and the film 26 bended on a conveying path roll during the manufacturing processes of the polarizing plate. The polarizing plate which was manufactured by using the film 26 in Comparative Example 1 largely warped, so that bonding of the polarizing plate to glass was difficult.

In Comparative Example 2, the plasticizer content ratio of the film 26 was very small and its value was 1.08. Consequently, the processability was degraded, and at several positions along a circumferential edge created by stamping, it was observed that the film 26 exfoliated from the polarizing film.

On the contrary, in Examples 1 and 2, plasticizer content ratios of the films 26 were within a range from 1.2 to 2.0, and each curvature radius in water at 25° C. was 25 mm or more. Therefore, the films 26 in Examples 1 and 2 exhibited well-balanced properties in terms of the handling property as well as the processability.

In each of the above-described experiments, the curvature radius in water was determined by cutting off a rectangular piece having a width of 35 mm and a length of 3 mm from the finished film 26, dipping the piece into water at 25° C. for 30 minutes, and reading its curvature radius.

The volatile content was calculated from the following equation:
Volatile Content (%)=(A−B)/B×100,
where A is weight (g) of a film sample and B is weight (g) of the film sample after drying it for one hour within a thermostatic air chamber at 115° C.

The plasticizer content ratio was determined as follows. That is, one side of the film 26 was scraped off with a twin bladed razor for example such that a thickness of the film 26 was reduced by half, then the remaining film piece was dissolved in chloroform, and finally, its plasticizer content was analyzed by gas chromatography. The same treatment was performed on the other side of the film 26, then a value of a plasticizer content of the substrate side 26A was divided by a value of a plasticizer content of the air side 26B to obtain the plasticizer content ratio. In this analysis, GC-14A Gas Chromatograph manufactured by SHIMADZU Corp. was used, OV-17 was used as a column filler, and a temperature of the column was 280° C.

According to the cellulose acylate film of the present invention as described above, the ratio of the plasticizer content of one-half portion of the film along the thickness direction thereof to the plasticizer content of the other-half portion of the film is between 1.2 and 2.0, and the curvature radius of curling in water at a temperature of 25° C. is 25 mm or more. Therefore, the polarizing film can be easily laminated with the film, and the laminated film can be subjected to stamping without causing chipping or stripping on the edge portion of the stamped film.

In addition, the polarizing plate according to the present invention does not warp largely, so that this polarizing plate can be easily stuck on other materials such as glass.

It should be understood, however, that there is no intention to limit the invention to the specific forms disclosed, but on the contrary, the invention is to cover all modifications, alternate constructions and equivalents falling within the spirit and scope of the invention as expressed in the appended claims.

1. A cellulose acylate film, wherein:
a ratio of a plasticizer content of a half portion of the film along a thickness direction thereof to a plasticizer content of the other half portion of the film is between 1.2 and 2.0; and
a curl radius of the film in water at a temperature of 25° C. is 25 mm or more;
wherein the film is prepared by flow-casting dope on a substrate to produce a self-supporting said film, stripping the film from the substrate, and blowing drying air at a temperature of at least 115° C. on a side of the film that had been facing the substrate.

2. The cellulose acylate film according to claim 1, consisting essentially of cellulose acetate of which substitution degree is 2.5 or more.

3. A polarizing plate, wherein a polarizing film is laminated with the cellulose acylate film according to claim 1 as a protective film.

4. A polarizing plate, wherein a polarizing film is laminated with the cellulose acylate film according to claim 2 as a protective film.

5. A cellulose acylate film, wherein:
a ratio of a plasticizer content of a half portion of the film along a thickness direction thereof to a plasticizer content of the other half portion of the film is between 1.2 and 2.0; and
a curl radius of the film in water at a temperature of 25° C. is 25 mm or more;
wherein the film is prepared by flow-casting dope on a substrate to produce a self-supporting said film, stripping the film from the substrate, and blowing drying air having a temperature of at least 115° C. at a rate of no more than 3 m/s on a side of the film that had been opposite the substrate.

6. The cellulose acylate film according to claim 5, consisting essentially of cellulose acetate of which substitution degree is 2.5 or more.

7. A polarizing plate, wherein a polarizing film is laminated with the cellulose acylate film according to claim 5 as a protective film.

8. A polarizing plate, wherein a polarizing film is laminated with the cellulose acylate film according to claim 6 as a protective film.

9. A cellulose acylate film, wherein:
a ratio of a plasticizer content of a half portion of the film along a thickness direction thereof to a plasticizer content of the other half portion of the film is between 1.2 and 2.0; and
a curl radius of the film in water at a temperature of 25° C. is 25 mm or more;
wherein the film is prepared by flow-casting dope on a substrate to produce a self-supporting said film, stripping the film from the substrate, and blowing drying air having a temperature of at least 115° C. on both a side of the film that had been opposite the substrate and a side of the film that had been facing the substrate.

10. The cellulose acylate film according to claim 9, consisting essentially of cellulose acetate of which substitution degree is 2.5 or more.

11. A polarizing plate, wherein a polarizing film is laminated with the cellulose acylate film according to claim 9 as a protective film.

12. A polarizing plate, wherein a polarizing film is laminated with the cellulose acylate film according to claim 10 as a protective film.

13. A method of making a cellulose acylate film, comprising the steps of:
flow-casting dope on a substrate to produce a self-supporting film, the dope comprising a mixture of hydrophobic plasticizer and cellulose acylate;
stripping the film from the substrate; and
blowing drying air at a temperature of at least 115° C. on at least one side of the film;
wherein a composition of the mixture and the step of blowing drying air are set such that, at a conclusion of the method, a ratio of a plasticizer content of a half portion of the film along a thickness direction thereof to a plasticizer content of the other half portion of the film is between 1.2 and 2.0 at a conclusion of the method; and
a curl radius of the film in water at a temperature of 25° C. is 25 mm or more.

14. The method of claim 13, comprising a further step of blowing drying air having a temperature of less than 115° C. onto the film.

15. The method of claim 13, wherein the step of blowing drying air is performed such that the drying air is directed toward only a side of the film that was in contact with the substrate prior to being stripped away from the substrate.

16. The method of claim 15, comprising the further step, after the blowing drying air step, of passing the dried film through a curl correction apparatus.

17. The method of claim 16, wherein the curl correction step comprises blowing one of solvent gas and steam onto a side of the film that faced away from the substrate when the film was stripped away from the substrate.

18. The method of claim 13, wherein the step of blowing drying air is performed such that the drying air is directed toward only a side of the film that faced away from the substrate when the film was in contact with the substrate.

19. The method of claim 18, wherein the drying air has a velocity no greater than 3 m/s.

20. The method of claim 18, comprising the further step, after the blowing drying air step, of passing the dried film through a curl correction apparatus.

21. The method of claim 20, wherein the curl correction step comprises blowing one of solvent gas and steam onto a side of the film that faced away from the substrate when the film was stripped away from the substrate.

22. The method of claim 13, wherein the step of blowing drying air is performed such that the drying air is directed toward both sides of the film.

23. The method of claim 22, comprising the further step, after the blowing drying air step, of passing the dried film through a curl correction apparatus.

24. The method of claim 23, wherein the curl correction step comprises blowing one of solvent gas and steam onto a side of the film that faced away from the substrate when the film was stripped away from the substrate.

25. The method of claim 13, comprising the further step, after the blowing drying air step, of passing the dried film through a curl correction apparatus.

26. The method of claim 25, wherein the curl correction step comprises blowing one of solvent gas and steam onto a side of the film that faced away from the substrate when the film was stripped away from the substrate.

27. The method of claim 26, wherein the curl correction step comprises blowing only solvent gas onto the film.

28. The method of claim 26, wherein the curl correction step comprises blowing only steam onto the film.

29. The method of claim 28, wherein the curl correction step comprises lowering a temperature of the film.

30. The method of claim 29, wherein the curl correction step is performed such that the lowering of the temperature of the film while blowing steam onto the film does not result in condensation forming on the film.

31. The method of claim 29, wherein the temperature of the film during the curl correction step is controlled by controlling a temperature of ambient air.

32. The method of claim 29, wherein the temperature of the film during the curl correction step is controlled by controlling a temperature a contact roll around which the film is passed.

33. The method of claim 13, wherein the film produced by the method consists essentially of cellulose having a substitution degree is 2.5 or more.
